(19) United States
(12) Patent Application Publication
(10) Pub. No.: US 2008/0092359 A1
(43) Pub. Date: Apr. 24, 2008

(54) METHOD FOR MANUFACTURING NON-SLIP METALLIC SHELLS

(75) Inventors: HUNG-CHANG LEE, Taipei Hsien (TW); YU-CHUAN CHEN, Shenzhen (CN); CHUANG LIU, Shenzhen (CN); JIAN-PENG YU, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignees: SHENZHEN FUTAIHONG PRECISION INDUSTRIAL CO.,LTD., Shenzhen (CN); SUTECH TRADING LIMITED, Tortola (VG)

(21) Appl. No.: 11/767,007

(22) Filed: Jun. 22, 2007

(30) Foreign Application Priority Data
Oct. 18, 2006 (CN) 200610063189.4

(51) Int. Cl. B23P 17/04

(52) U.S. Cl. 29/416; 361/679

(57) ABSTRACT

A method for manufacturing a metallic shell (100) from a base shell made of metal is provided. The metallic shell includes an grippable portion (12). The method includes six steps, as follows. The base shell is formed (S1). The base shell is ground (S2) and burnished (S3) and then washed and cleaned (S4). The grippable portion of the metallic shell is engraved (S5) to yield a texture approximating a wood grain. Finally, the base shell is anodically treated (S6).

### BACKGROUND OF THE INVENTION

1. Field of the Invention

The present invention relates to a method for manufacturing a metallic shell for a portable device and, particularly, to a method for manufacturing a metallic shell with a grippable, non-slip surface.

2. Description of Related Art

Metallic shells are widely used in many technological fields. One example is a metallic shell used with a portable electronic device (e.g., a mobile phone) for shielding internal electronic components. Another example is a metallic shell used with a piece of furniture (e.g., a mini sofa) to provide decoration.

Typically, exterior surfaces of metallic shells have a baked-on finish. After such treatment, metallic shells are given an attractive smooth texture and a beautiful appearance. However, some applications require a non-slip finish. Obviously, such metallic shells treated by baking finish technology are insufficiently grippable. Also, the exterior surfaces of metallic shells with a baked-on finish can easily become abraded/worn and even damaged during daily use.

Therefore, a heretofore-unaddressed need exists in the art to address the aforementioned deficiencies and inadequacies.

### SUMMARY

In one aspect, a method for manufacturing a metallic shell from a base shell made of metal is provided. The metallic shell includes a grippable portion. The method includes six steps, as follows. The base shell is formed. The base shell is first ground and burnished; and then washed and cleaned. The grippable portion of the metallic shell is created by engraving. Finally, the base shell is anodically treated.

In another aspect, the metallic shell, manufactured by implementing the aforementioned method, is provided. The metallic shell includes an exterior surface. The grippable portion is formed on the exterior surface.

### BRIEF DESCRIPTION OF THE DRAWINGS

Many aspects of the metallic shell and the method for manufacturing the same can be better understood with reference to the following drawings. These drawings are not necessarily drawn to scale, the emphasis instead being placed upon clearly illustrating the principles of the present metallic shell and the method for manufacturing the same. Moreover, in the drawings like reference numerals designate corresponding parts throughout the several views. Wherever possible, the same reference numbers are used throughout the drawings to refer to the same or like elements of an embodiment.

FIG. 1 is a partial, schematic, top view of a metallic shell, in accordance with a present embodiment;

FIG. 2 is a flowchart of a method for manufacturing the metallic shell shown in FIG. 1; and

FIG. 3 is a top view of an engraving apparatus combined with a base shell for manufacturing the metallic shell shown in FIG. 1.

### DETAILED DESCRIPTION OF PREFERRED EMBODIMENTS

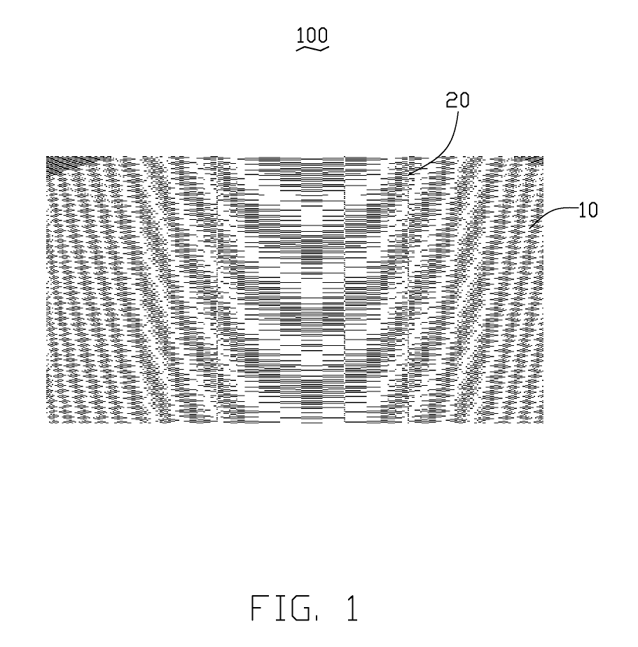

The present metallic shell and the method for manufacturing the same are described here, in conjunction with FIGS. 1-3. The metallic shell is potentially usable in any of a variety of fields. Such a metallic shell is quite useful in a portable electronic device, such as a mobile phone, a digital camera, or the like. However, it is to be understood that such a metallic shell could be used, e.g., in furniture, as well.

Referring to FIG. 1, the metallic shell 100 is configured (i.e., structured and arranged) to shield electronic components (e.g., a printed circuit board and a transducer) of a portable electronic device. The metallic shell 100 includes an exterior surface 10. The metallic shell 100 includes a grippable portion 20 formed on the exterior surface 10. The grippable portion 20 approximates a wood-grain texture. The grippable portion 20 includes a plurality of recessed sections (not labeled). The recessed sections are evenly arranged and distributed on the exterior surface 10 of the metallic shell 100.

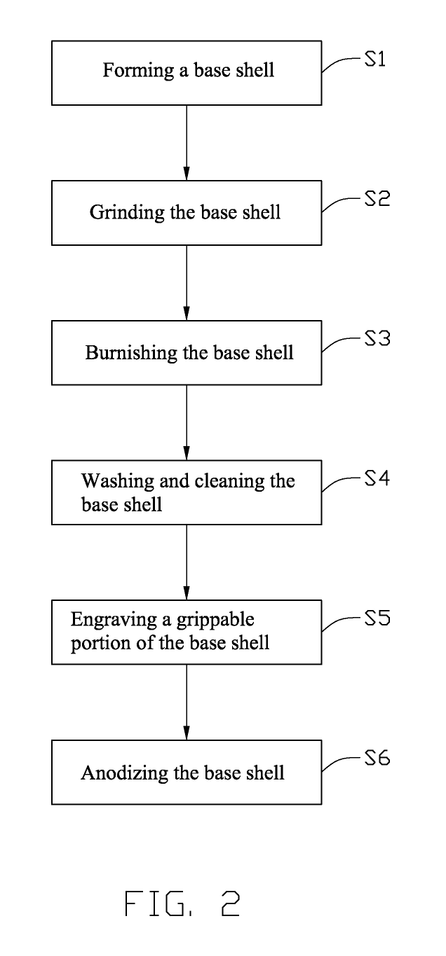

Referring also to FIG. 2, the method for manufacturing the metallic shell 100 with a wood-grain appearance includes a series of steps, as follows.

Step S1 is performed to form a base shell made of a metal (e.g., aluminum, titanium, or an alloy thereof, or stainless steel). The base shell can be formed by various kind of metal forming technology. In a beneficial embodiment, the base shell is initially formed by punching.

Following, step S2 is enacted to grind an exterior surface of the base shell. At this step, some impurities and/or some burrs can be removed from the exterior surface of the base shell.

Then, in step S3, the ground base shell is burnished. During this step, the base shell is burnished to eliminate scuffing on the exterior surface of the base shell.

Step S4 includes washing and cleaning of the burnished base shell, applying such a degreaser as a NaOH (sodium hydroxide) alkaline solution, a surfactant, etc. Impurities, such as oil impurities, lubricant impurities, etc., are washed/cleaned from the base shell.

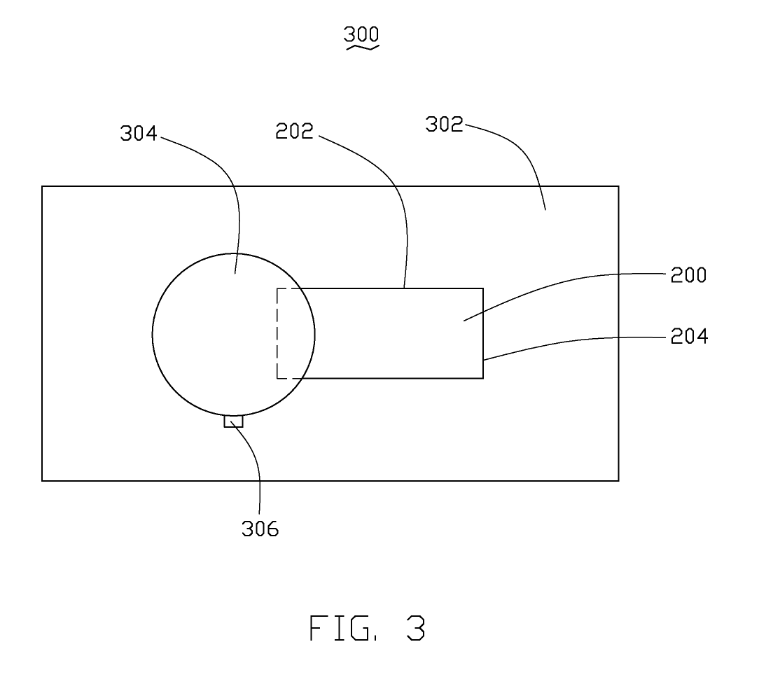

After that, step S5 is carried out to engrave and form the grippable portion 20 of the exterior surface of the present provided base shell. An engraving machine (not shown) is used during this step S5. Referring further to FIG. 3, the present provided base shell 200 is held/clamped on a machining platform 302 of the engraving machine 300. The wood-texture engraving machine 300 includes a circular disk-shaped milling slide 304 and a milling tool 306. The milling tool 306 is fixed to an outside peripheral wall of the milling slide 304. The base shell 200 includes two relatively long opposing sides 202 and two opposing shorter sides 204. The milling slide 304 is configured to be longer than the shorter sides 204 of the base shell 200. The milling slide 304 with the milling tool 306 is located above the machining platform 302. The exterior surface of the base shell 200 diametrically faces the milling tool 306 and is partially covered by the milling slide 304. Specifically, one shorter side 204 of the base shell 200 is thoroughly covered by the milling slide 306, and the other shorter side 204 of the base shell 200 is uncovered by the milling slide 304. Two longer sides 202 of the base shell 200 are partially covered by the milling slide 304.

During milling, the milling slide 304 combined with the milling tool 306 firstly rotates about a central axis of the milling slide 304 at high speed, while moving in a longitudinal direction with respect to the base shell 200. The exterior surface of the base shell 200 is milled to form a first recessed portion (not shown). The first recessed portion is of parabolic shape due to the milling slide 304 being larger than the shorter side 204 of the base shell 200.

The milling slide 304 combined with the milling tool 306 then continues rotating about a central axis thereof at high speed, whilst stopping to move longitudinally and thus maintain its previous height relative to the base shell 200. The machining platform 302 combined with the base shell 200 slowly moves transversely relative to the milling tool 306. In other words, the base shell 200 moves along the longer side 202 of the base shell 200. During this process, the exterior surface of the base shell 200 is milled twice with the milling tool 306. During the first milling step, a plurality of parabolic first recessed portions is milled. The first recessed portions are spaced from each other and are arranged evenly on the exterior surface of the base shell 200.

During the second milling step, a plurality of parabolic second recessed portions (not shown) is milled. The second recessed portions are formed in/at respective intersections with the first recessed portions. The second recessed portions are also spaced from each other and are arranged at even intervals along the exterior surface of the base shell 200. Thus, the first and second recessed portions cooperatively form the recessed parabolic sections. The recessed sections cooperatively form the grippable portion 20 of metallic shell 100, which is thereby given a texture approximating that of wood. In the example illustrated in FIG. 1, the grippable portion 20 includes essentially two distinct sets of parabolic recesses, each facing an outer longitudinal edge of the exterior surface 10, in a longitudinal-center out fashion. Accordingly, recesses from the two sets that are proximate the longitudinal centers intersect with recesses of the other set.

Step S6 includes an anodic treatment of the milled base shell. Corrosion resistance and wear resistance are thus enhanced.

Therefore, the preferred metallic shell 100 is finally formed by the aforementioned method. The exterior surface of metallic shell 100 includes the grippable portion 20 formed thereon for improving grip and thereby facilitating surer handling thereof. In other words, a plurality of recessed sections of the metallic shell 100 is configured in such a particular manner (i.e., each arranged/distributed in a parabolic shape) such that the metallic shell 100 cannot easily slide when held by another surface. Furthermore, the metallic shell 100, manufactured by the aforementioned method, has a high corrosion and wear resistance.

It is to be understood, however, that even through numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for manufacturing a metallic shell from a base shell made of a metal, the metallic shell including a grippable portion, comprising steps of:
forming the base shell;
at least one of grinding and burnishing the base shell after forming thereof;
at least one of washing and cleaning the base shell;
engraving the base shell to thereby form the grippable portion thereof; and
anodizing the base shell.

2. The method as claimed in claim 1, wherein during the engraving process, an exterior surface of the base shell is engraved twice to form the grippable portion.

3. The method as claimed in claim 2, wherein during the engraving process, an engraving machine is provided with a machining platform and a milling slide combined with a milling tool, and the base shell is fixed to machining platform.

4. The method as claimed in claim 3, wherein the milling tool is fixed to a peripheral wall of the milling slide during the engraving process, the milling tool rotating about an axis of the milling slide, the base shell combined with the machining platform moving relative to the milling slide.

5. The method as claimed in claim 3, wherein the base shell includes a longer side and a shorter side, and the milling slide is larger than the shorter side.

6. A metallic shell, comprising:
an exterior surface; and
a grippable portion defined on the exterior surface, the grippable portion approximating a wood texture.

7. The metallic shell as claimed in claim 6, wherein the grippable portion comprises a plurality of recessed sections, and the recessed sections are evenly arranged and distributed on an exterior surface of the metallic shell.

8. The metallic shell as claimed in claim 6, wherein the grippable portion includes at least two distinct sets of parabolic recesses.

9. A method for manufacturing the metallic shell, the metallic shell being manufactured from a base shell made of metal, comprising steps of:
providing the base shell; and
engraving the base shell to thereby form a grippable portion thereon.

10. The method as claimed in claim 9, wherein during the engraving process, an exterior surface of the base shell is engraved twice to form the grippable portion.

11. The method as claimed in claim 9, wherein the grippable portion has a texture approximating a wood grain.
